(19) United States
(12) Patent Application Publication
(10) Pub. No.: US 2016/0059196 A1
(43) Pub. Date: Mar. 3, 2016

(54) Simplex electric circuit

(71) Applicant: Edward Milton McWhorter, Citrus Hieghts, CA (US)

(72) Inventor: Edward Milton McWhorter, Citrus Hieghts, CA (US)

(21) Appl. No.: 14/121,418

(22) Filed: Sep. 3, 2014

(51) Int. Cl. B01J 4/02; H01G 9/035; H01G 9/145

(52) U.S. Cl. CPC B01J 4/02; H01G 9/145; H01G 9/035

(57) ABSTRACT

A rotating spindle shaft is used as a valving mechanism for dispensing finite quantities of fluidized alkaline metals at regular spaced intervals into a reaction chamber for hydrolyzation to produce intense discrete surges of electron flow that generate an oscillatatory pulsing direct current (dc) for transformer operation. Pulsing direct current transformers are more efficient than alternating current transformers because the current flow is only in one direction such that hysteresis losses are low where the transformer iron core magnetic field reversal does not occur during the period of spindle shaft off flow and therefore does not inhibit the high rate of collapsing magnetic field lines of force cutting across a stationary metal conductor.

### CROSS REFERENCES

Ref. 1 U.S. Pat. No. 6,831,825 Fuel Cell Ionic Capacitor
Ref. 2 U.S. Pat. No. 8,071,041 Potassium Electric Generator and Chemical Synthesizer
Ref. 3. U.S. Pat. No. 8,454,900 Alkaline Metal Fuel Pulse Generator

### CLAIM OF PRIORITY

The present application claims priority from U.S. application Ser. No. 12/587,102 filed Oct. 2, 2009 Publication US-2011-0079747 A1 Publication Date Apr. 7, 2011 the content of which is hereby amended and incorporated by reference into this application.

### BACKGROUND OF THE INVENTION

An electrical current is generated at regular intervals to produce intense individual pulses of direct current electron flow that is released during the cyclic hydrolysis of small quantities of fluidized alkaline metals, Li, Na, K, and with mixtures of alkaline earth metals, Ca and Mg, in a reaction chamber. The mechanism used for dispensing the said alkaline metals into the said reaction chamber is a rotatively mounted spindle shaft having an orifice which opens and closes the flow of liquid alkaline metals through a valve block passages producing discrete segmented flowing quantities of the said fluidized alkaline metals at evenly spaced controlled intervals.

The liquid medium flowing through the spindle shaft orifice and valve block passages are heated alkaline metals, principally sodium (Na) at 210° F. or potassium and sodium mixtures that exist in the liquid state at normal room temperature. The alkaline metal enters the simplex generator valve block at its inlet passage and passes into a rotating spindle shaft orifice and exits the valve block exit passage as finite quantities of pulsed flow which are approximately equivalent in volumetric measure to the spindle shaft orifice volume. The pulsed flow exits the simplex generator at regularly spaced intervals corresponding to the rate of rotation of the spindle shaft. One complete revolution of the spindle shaft in the valve block opens and closes the alkaline metal flow circuit through the valve block two times. The spindle shaft is rotated at 30 rpm opening and closing the flow 60 times in one minute producing 60 pulses at 1 hz intervals.

Alkaline metal flow to the simplex generator valve block inlet passage is induced by a low volume high pressure pumping system. The pressurized metal flow passes out of the simplex generator valve block exit passage in regularly spaced finite pulses into an injector where it is hydrolyzed by an impinging water jet. The alkaline metals entering the injector react exothermally with the injector water spray during hydrolyzation rupturing the hydrogen to oxygen bonds of the water molecules releasing electrons (e⁻) and positive charged subatomic protons (H⁺) as a diffusion mixture shown in Eq. 1.

Na+H₂O→NaOH+H⁺e⁻ Eq. 1

Simplex generators are best used in direct current electrical generation for transformer operation, a task most generally reserved for alternating current (ac) circuits. Pulsing direct current transformers are more efficient than alternating current transformers because the current flow is only in one direction such that hysteresis losses are low where the transformer iron core magnetic field reversal does not occur during the period of spindle shaft off flow and therefore does not inhibit the high rate of collapsing magnetic field lines of force cutting across a stationary metal conductor. The electrical current released during hydrolyzation is equal to the electrochemical equivalence of the energy stored in a given quantity of alkaline metal during electrolysis reduction necessary to reduce the metal to its elemental state. The stored energy in the reduced metal is released during hydrolysis of the metal resulting in oxidation and return to the original energy level in accordance with the First Law of Thermodynamics. The stored energy released in the hydrolysis reaction is used to chemically separate by hydrolysis the hydrogen to oxygen bond (H—O) of water which is about 110 kcal. The hydrolysis of sodium (Na) is used as a typical example of Group 1 alkaline metals (Li, Na, K) presented as Eq. 1 and also with alkaline earth metals of Group II (Mg, Ca) in accordance with their respective equivalent chemical bonding valences relative to Eq. 2.

The oxidation of 1 lb of sodium by hydrolyzation produces 528 ampere hours of electric current.

$$Amp \text{-} hrs \text{/} lb = \frac{coulombs \times grams}{Na eq . wt \times seconds} = \frac{96 , 500 \times 453.59}{22.99 \times 3600} = 528 \qquad Eq . 2$$

One pound (1 Ib) of molten sodium at a temperature of 210° F. is segmented into 3600 finite equivalent parts. Each part weighs 126 mg. Segmentation occurs at 1 hz evenly spaced intervals producing 30 coulombs (Q) per second by hydrolyzed reaction in the reaction chamber.

126 mg Na+H—OH→NaOH+H⁺e⁻→30.00 coulombs Eq. 3

The hydrolyzation reactions Eq. 3 also produces 1.884×10²⁰ electrons per second. The released electrons produce a current flow measured in amperes (I). One ampere produces a current flow of about 6.28×10¹⁸ electrons. The coulombic (Q) rate of electrons released in 1 hz intervals (Q hz/dt) during 1 second period of hydrolyzation (t) is scaleable when the current flow, measured in amperes (I), is known.

Q=I×t/sec. Eq. 4

The hydrolyzation of the segmented sodium produces a pulsating direct current flow (dc) that is directly proportional to the weight of the finite quantity of the evenly spaced fuel segment.

The dissociated fluid products of Eq. 1 are passed into an ionic capacitor of Ref. 1 which is installed in the fluid circuit in Ref. 2 and is hereinafter referred to as a “tuyere”. The negative charges (e⁻) of Eq. 1 are electrostatically transferred from the charged tuyere metal strake surfaces to dielectric capacitors of Ref. 2. The tuyere strakes and dielectric capacitor systems function in unison and are hereinafter referred to as a “capacitor tuyere”. The capacitor tuyere is used to produce free electron charges (e⁻) for electrical generation. Electric dc current produced by the “Simplex Generator Set” is more efficient because a field charge has no mass and therefore the duration of magnetic retention cutting across a fixed metal conductor is equal to the spindle shaft maximum induced amplitude (Qₒ) and the useful period of transmission (Qt) is of longer duration. The cyclic duration Qₜ is approximately given by the expression of Eq. 5.

Qₜ=Q_{o∈}^{-bt} Eq. 5

Where Qt is spaced at 1 hz intervals, Qₒ is maximum amplitude, and (b) is a constant decrement of retention of the conductor circuit die away factor ∈=^{-bt}.

Sodium is chosen in the demonstration example presented because it is the least expensive of the alkaline metals which are to be used in the process and it is important to note, Sodium is 33 times more abundant in the earth's crust than the total sum of all fossil fuels (petroleum, coal, natural gas). Alkaline metal electrolytic fuels are also used in the battery circuits of domestic electric cars. Electrolytic fuels are also used in larger locomotive applications, as in marine and heavy equipment and as standby electrical grid service. The cost of hydroelectric generated sodium based electrolytic fuel is about $0.50/lb. Wind and solar generated sodium electrolytic fuels will cost about $1.00/lb.

The amount of electric current produced when a conductor cuts across the lines of force of a magnetic field varies proportionately with the rate at which the lines of forces are cut. Generator armature wire conductor fields have mass (m). The rotative effort (F) of an armature is an exponential function of the product of the rotational speed (v²) at which the mass (m) armature rotates through the magnetic field lines of force (F=mv²). Because the simplex generator does not employ a rotating mass its generating capacity depends only on the rate of the speed of the magnetic lines of force in the collapsing pulse die-away factor which cuts across the primary winding that is being inducted into the secondary winding of a transformer or of an inductive motor field windings. Generator armature masses move in a restricted circular arc which is determined by the number of rotor or stator fields, resulting in a constantly changing rate of magnetic force lines of cleavage producing a variable combined vectored momentum of individual impulses of torque. The physical weight of generator armature mass induced impulses encumber the efficiency of the system by higher kinetic mass momentum loss which is additive to the iron core hysteresis loss. These losses are eliminated in the present invention by reversing the system component operating function. The magnetic field is moved through a stationary conductor mass at a very high rate when the magnetic field collapses during the off period of fluid flow through the spindle shaft orifice channel.

### SUMMARY OF THE INVENTION

It is the primary object of the invention to provide a novel means of dispensing finite quantities of chemically reactive alkaline metal fluids into a reaction chamber at regularly spaced intervals through an orifice of a spindle shaft rotating unidirectionally in a valving circuit at a constant rate.

It is another object of the invention to use a spindle shaft rotating at constant speed and having an orifice which opens and closes the flow of an alkaline metal fluid circuit to a hydrolyzation chamber to generate a pulsed release of electrochemical equivalent electron flow to produce a pulsing direct current electrical circuit.

It is yet another object of the invention to chemically generate at evenly spaced intervals a strong electromagnetic discharge of negative charged electrons and an associative stream of positive charged ions for electrophoretic synthesis.

### BRIEF DESCRIPTION OF THE DRAWINGS

Five drawings are presented. The proprietary novel features of the invention are presented in FIGS. 1-3 which describe the features of the valving circuit. FIGS. 4 and 5 are supplementary drawings used to describe how the valving circuit is to be used.

FIG. 1 is a side view of a spindle shaft and valving orifice.

FIG. 2 is a cross-section of FIG. 1

FIG. 3 is an assembly drawing of the spindle shaft mounted in a block comprising the valving elements of a simplex valving circuit shown principally in cross-section.

FIG. 4 is a drawing of the simplex valving circuit assembled within the dual electrical generating and chemical synthesis circuits.

FIG. 5 is a diagram of the 1 hz dc pulsing capability of the invention to create strong electrical impact surges necessary for electrophoretic synthesis and efficient grid transfer.

### DETAILED DESCRIPTION OF THE INVENTION

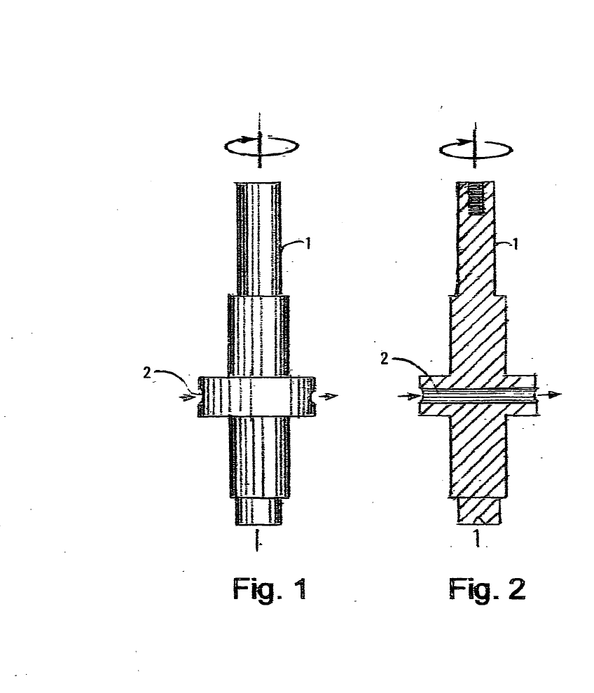

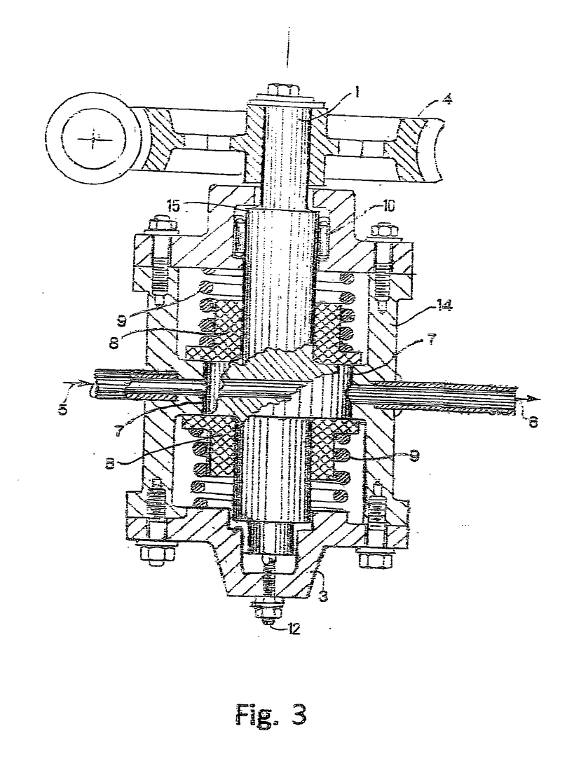

FIG. 1 is a side view of spindle shaft 1 which has an orifice 2 drilled perpendicular through its axis as shown in FIG. 2 cross-section. Spindle shaft 1 is rotatively mounted in valve block 14 as shown in FIG. 3. Spindle shaft 1 is rotated in valve block 14 by worm gear 4. Valve block 14 has an inlet port 5 and exit port 6 that are aligned at the same horizontal elevation of orifice 2 such that when gear 4 rotates one revolution inlet port 5 is opened and closed twice allowing flow of an alkaline metal through orifice 2 and out at exit port 6. Spindle shaft 1 is in rotative contact 7 with valve block 14 at sealing surface contact at two points. Stationary Teflon seals 8 mounted around the stems of spindle shaft 1 and held in compressive load by compression springs 9. Vertical alignment of spindle shaft 1 orifice 2 with valve block 14 inlet port 5 and exit port 6 is achieved by adjustment screw 12 tightening spindle shaft 1 against needle bearing 10 at notch 15.

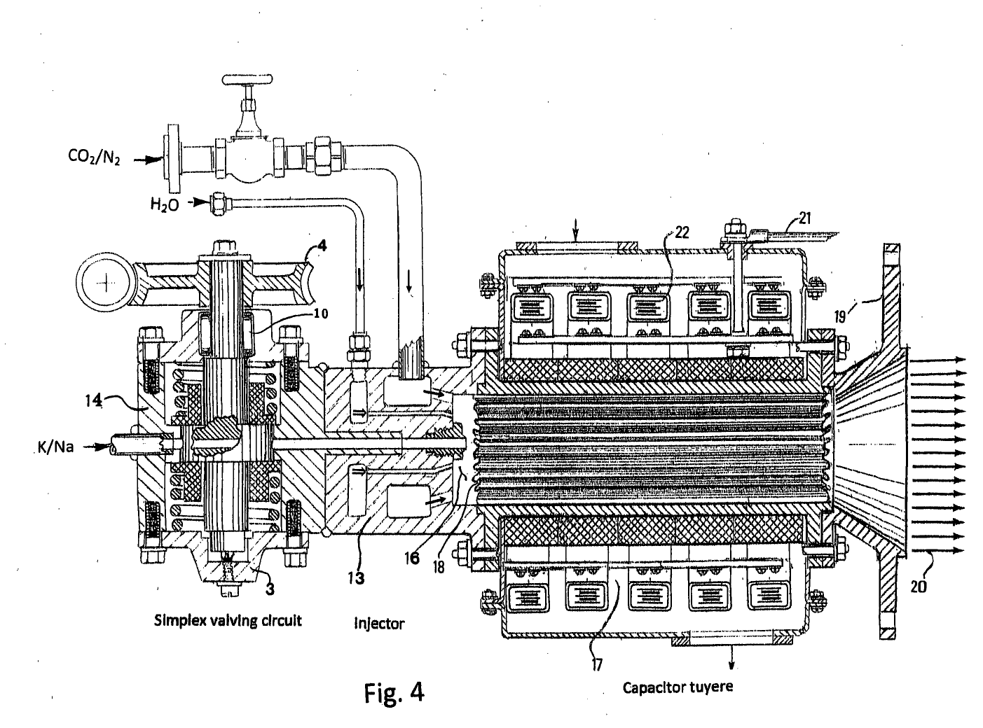

FIG. 4 is the Simplex Valving Circuit of FIG. 3 placed in process assembly with the injector block 13 which is in turn bolted to capacitor tuyere 17. Alkaline metal flows through exit port 6 of injector block 14 and passes through injector block 13 into hydrolyzation chamber 16 where it is mixed with CO₂ and N₂ and passes into the capacitor tuyere 17 inner tubular structure which hold ionic capacitor finned surfaces hereinafter called capacitor strakes 18. The capacitor strakes 18 absorb electron charges from the hydrolyzation products which are transferred to dielectric capacitors 22 as pulsed 1 hz current surges. The current surges produced are carried out of the dielectric capacitors by dc pulse conductor 21. The remaining hydrolyzation products are positive charged ionic stream 20 which exits the capacitor turyere 17 through nozzle 19.

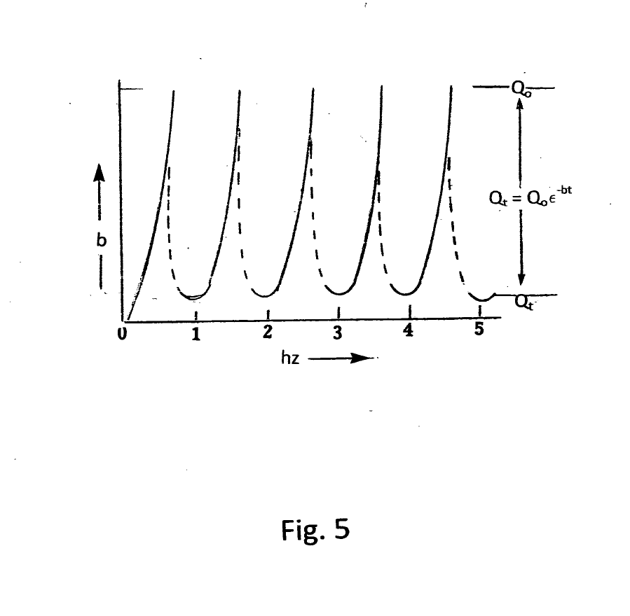

FIG. 5 is a graphical chart of 1 hz electrical pulses where b is a constant of decrement in the die-away of electrical shock current hydrolyzation pulse generated by the Simplex Valving Circuit.

### NUMBERED ELEMENTS OF THE INVENTION

1. shaft
2. orifice
3. valve plate
4. gear
5. inlet port
6. exit port
7. contact point
8. seal
9. springs
10. needle bearing
11. - - -
12. adjustment screw
13. injector block
14. valve block
15. spacing notch
16. hydrolyzation chamber
17. capacitor tuyere
18. capacitor strakes
19. nozzle
20. positive ion stream
21. dc pulse conductor
22. dielectric capacitors

What is claimed is:

1. A spindle shaft rotatively mounted in a valve block, an orifice passage perpendicular through the longitudinal axis of the spindle shaft, the orifice in alignment with an inlet port and an exit port of the valve bock, heated alkaline metal entering the valve block through the inlet port and passing through the spindle shaft orifice and exiting the valve block through the exit port, the spindle shaft is unidirectionally rotated by a gear at a continuous turning rate of 30 revolutions per minute opening and closing the flow of heated alkaline metal through the valve block 60 times per minute producing 60 finite segmented quantities of heated alkaline metal flow per minute, the segmented heated alkaline flow discharged into a reaction chamber for hydrolyzation in a water spray, hydrolyzation of the segmented portions of the heated alkaline metal produces a corresponding coulombic surge of negative electron charges within the diffusion flow of the hydrolyzation reaction products of the diffusion mixture, a constant decrement of electron retention occurring within the diffuse mixture producing a constant variability of coulombic density, the diffuse mixture discharged out of the hydrolyzation chamber into a capacitor tuyere, the electrons within the coulombic density are electrostatically absorbed on the strakes of the capacitor tuyere, the electrons electrostatically absorbed on the capacitor strakes electrically conducted into a dielectric capacitor circuit producing pulsating dc current.
